(19) United States
(12) Patent Application Publication
(10) Pub. No.: US 2009/0121095 A1
(43) Pub. Date: May 14, 2009

(54) Paint can stand with adjustable pole

(76) Inventor: Al Eighmie, Bristol, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/290,878

(22) Filed: Nov. 3, 2008

Related U.S. Application Data
(60) Provisional application No. 61/001,541, filed on Nov. 1, 2007.

(51) Int. Cl. F16M 11/24

(52) U.S. Cl. 248/132

(57) ABSTRACT

A paint can stand is provided comprising a basket, an adjustable pole engaged with the basket, and a base configured for removable engagement with the adjustable pole. The adjustable pole has a first and second portion, the first portion having pegs extending outwardly therefrom, and the second portion having a hole dimensionally sized for engaging with the pegs. The base has a collar configured to receive the adjustable pole.

### CROSS REFERENCE TO RELATED APPLICATION

Reference is made to and priority claimed from U.S. provisional application Ser. No. 61/001,541, filed Nov. 1, 2007, entitled PAINT CAN STAND WITH ADJUSTABLE POLE.

### BACKGROUND OF THE INVENTION

1. Technical Field

The present invention relates to a paint can stand for holding paint cans; and more particularly to a paint can stand having a carrying handle and an adjustable pole, which provides height adjustment for various conditions.

2. Discussion of Related Art

Painters frequently use a stand up ladder having a folding tray to support a can of paint while the painter is painting. While this approach may be functional, there is always a chance that the paint can could tip over and spill the contents. In this exemplary situation, the paint can is not secured but rather rests on the top of the tray. Thus if a painter becomes careless or is distracted, there is a possibility of knocking the paint can off the ladder tray and spilling large quantities of paint.

It would be advantageous to provide the painter with an apparatus for holding the paint can that is not attached to the ladder yet is still adjustable in height, thus the paint can would not tip over if accidentally made unsteady by the painter's movements on the ladder. This problem can be eliminated if the painter uses a separate, adjustable stand capable of holding a gallon paint can, or a smaller paint can. The stand is further advantageous if provided with a handle allowing the painter to relocate the entire unit, i.e. the paint can engaged in paint can stand, simply by grasping and carrying the handle.

### SUMMARY OF THE INVENTION

In accordance with a first broad aspect of the invention, a paint can stand comprises a basket configured for receiving and holding a paint can, an adjustable pole configured for engaging and supporting the basket, and a base configured for detachably receiving and securely holding one end of the adjustable pole so as to provide a foundation for the paint can stand. The adjustable pole has a first and second portion, the first portion having a plurality of aperture and corresponding pegs arranged along its longitudinal axis, each peg being configured to be responsive to a force, for being pushed into a respective aperture when the force is applied, and for being extended outwardly from the respective aperture when the force is not applied; and the second portion having a hole dimensionally sized for receiving and engaging one of the plurality of the pegs when the force is applied then released so as to adjust the paint can stand to a particular height for holding the paint can in the basket. The base has a collar configured to receive the adjustable pole. The first portion, the second portion and the base are detachably coupled together so that the paint can stand can be quickly and easily assembled together for use and disassembled and easily stored when not in use.

In some embodiments, the basket can have a flexible handle pivotally attached thereto configured for lifting and carrying said paint can stand. In some embodiments, the base is configured in a substantially x-shaped arrangement. In some embodiments, the base is dimensionally sized to extend outwardly beyond an outermost periphery of the basket for increased base of support. In some embodiments, the base comprises a collar configured to removably affix the one end of the second portion of the adjustable pole. In some embodiments, the basket is substantially open and has spaced-apart supportive pieces extending from a supportive base of the basket to a top rim of the basket. In some embodiments, the supportive base of the basket has a substantially x-shaped configuration. In some embodiments, the basket is dimensionally sized to accommodate a gallon-sized paint can. In some embodiments, the handle is substantially arc-shaped and dimensionally sized to be able to freely swing from one side of the paint can stand to another side of the paint can stand while a can of paint is engaged in the paint can stand. In some embodiments, the basket is made of a light band metal. In some embodiments, the adjustable pole is made of aluminum. In some embodiments, the adjustable pole is made of steel. In some embodiments, the collar is removably affixed to the second portion of the adjustable pole using a peg and hole mechanism. In some embodiments, the collar is removably affixed to the second portion of the adjustable pole by screwing the one end of second portion into the collar. In some embodiments, the adjustable pole is extendable from 1 to 3 feet in height. In some embodiments, the adjustable pole is extendable from 3 to 6 feet in height. In some embodiments, the basket and the first pole portion are detachably coupled together, including being respectively configured for screwing together.

One embodiment is shown and described herein wherein a basket is configured for receiving and holding the paint can; an adjustable pole is configured for engaging and supporting said basket, the adjustable pole having a first and second portion, the first portion having a plurality of aperture and corresponding pegs arranged along its longitudinal axis, each peg being configured to be responsive to a force, for being pushed into a respective aperture when the force is applied, and for being extended outwardly from the respective aperture when the force is not applied, and the second portion having a hole dimensionally sized for receiving and engaging one of the plurality of the pegs when the force is applied then released so as to adjust the paint can stand to a particular height for holding the paint can in the basket; and a base being configured for detachably receiving and securely holding one end of the second portion of said adjustable pole so as to provide a foundation for the paint can stand, such that the first portion, the second portion and the base being detachably coupled together so that the paint can stand can be quickly and easily assembled together for use and disassembled and easily stored when not in use.

In other embodiments, the basket and the first pole portion may be detachably coupled together, including being respectively configured for screwing together, or being coupled together in a manner similar to the technique for coupling the second portion of the adjustable pole and the base.

Another embodiment is shown and described herein wherein the paint can stand comprises a basket configured for receiving and holding a paint can; an adjustable pole configured for detachably engaging and supporting said basket, said adjustable pole having first and second pole portions being dimensioned and configured so that one pole portion fits telescopically inside and slides in relation to the other pole portion so as to adjust the length of the adjustable pole and so that the first and second pole portions frictionally engaging with one another so as to remain frictionally locked in an adjusted position; a base configured for detachably coupling and securely holding either the first or second pipe portions so as to provide a foundation for the paint can stand; whereby the basket, the first portion, the second portion and the base all being detachably coupled together so that the paint can stand can be quickly and easily assembled together for use and disassembled and easily stored when not in use.

### BRIEF DESCRIPTION OF THE DRAWINGS

FIG. 1 shows a side view of the assembled paint can stand.

FIGS. 2A-2D show the separate elements of the paint can stand of FIG. 1.

FIG. 2A shows a top view of the base of the paint can stand of FIG. 1.

FIG. 2B shows a side view of the adjustable pole of the paint can, stand of FIG. 1.

FIG. 2C shows a top view of the basket of the paint can stand of FIG. 1.

FIG. 2D shows a side view of the basket of the paint can stand of FIG. 1.

FIG. 3 shows a side view of another embodiment of the assembled paint can stand.

### DETAILED DESCRIPTION

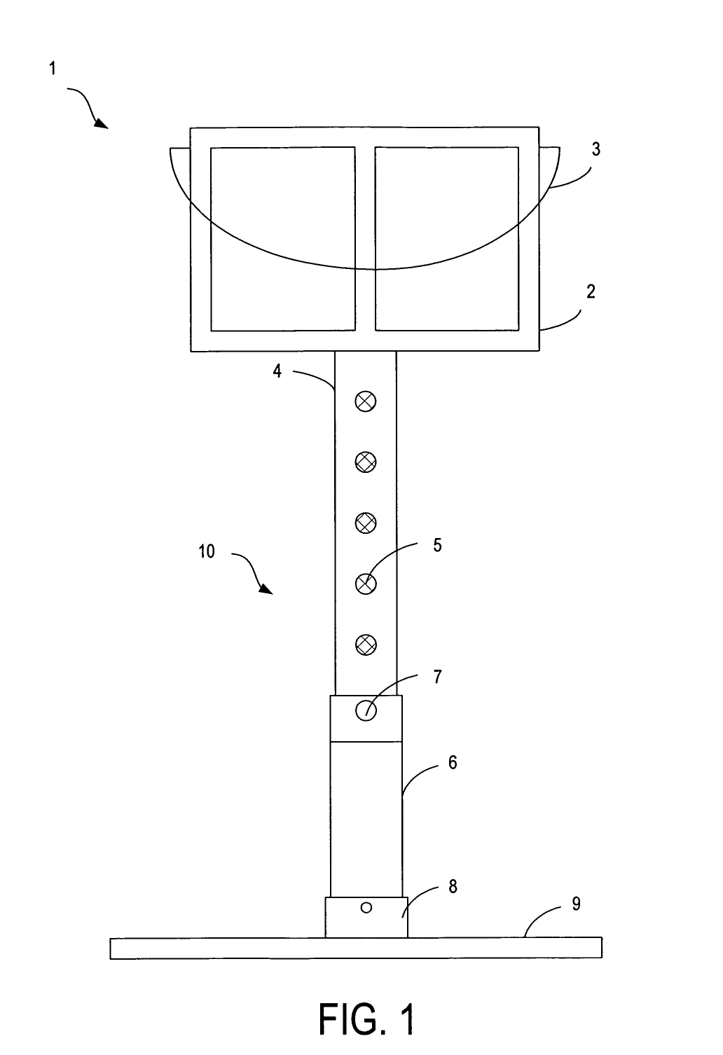

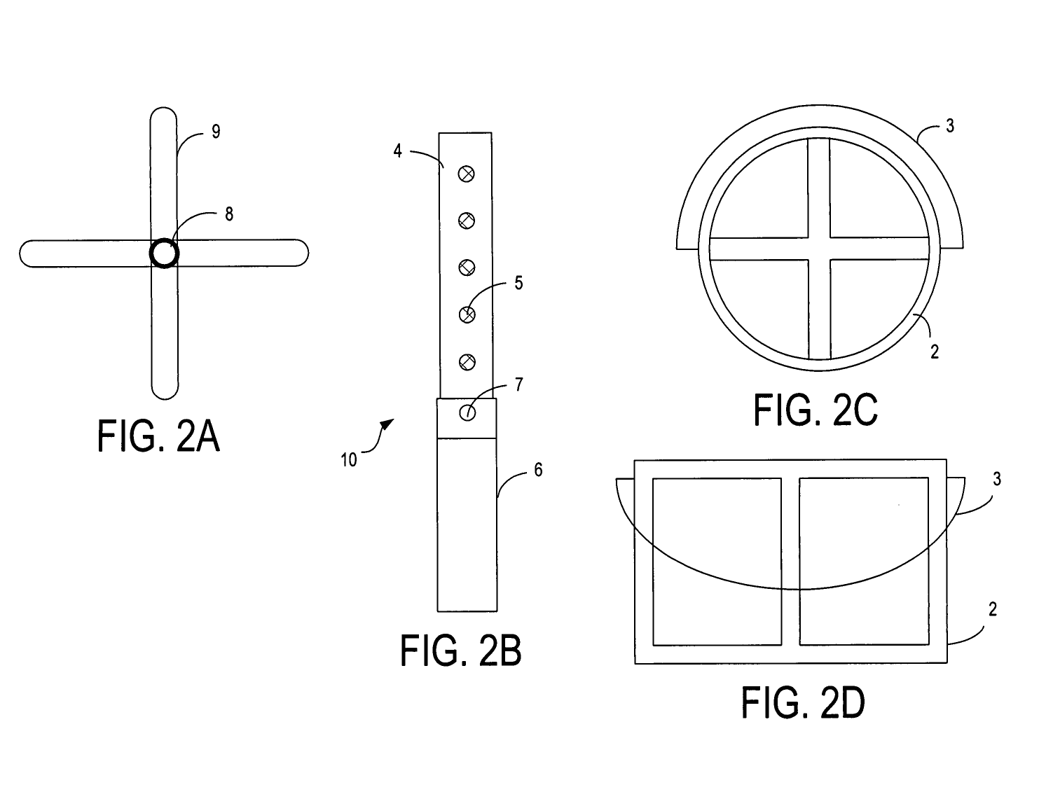

As shown in FIGS. 1 and 2A-2D, the present invention features a paint can stand (1) having a basket (2) for engagement with a paint can, the basket (2) being affixed to an adjustable pole (10) configured for height adjustment of the stand (1), and the adjustable pole (10) further being affixed to a base (9) for support. The basket (2) is cylindrical in shape and sufficiently wide and deep to contain a standard paint can, and may be comprised of a light band metal. The scope of the invention is not intended to be limited to the type or kind of material of which the basket is comprised of either now known or later developed in the future.

Affixed to the basket (2) is an easy-swing handle (3) used for carrying the paint can stand (1). The handle (3) is semi-circular in shape and is affixed to opposite sides of the basket (2). The handle (3) rests alongside the basket (2) when in the resting position and is in an arced position above the stand when being carried. The handle (3) is dimensionally sized to be able to make a full arc swing from side to side while a standard gallon-size paint can is situated inside the basket (2).

The adjustable pole (10) comprises two portions, which may be comprised of aluminum or steel. The scope of the invention is not intended to be limited to the type or kind of material from which the adjustable pole is made either now known or later developed in the future. The first portion (4) is a hollow cylindrical tube affixed at one end to the supportive bottom surface of the basket (2). Affixed to the first portion (4) of the adjustable pole (10) are evenly spaced pegs (5) for engaging with the second portion (6) of the adjustable pole (10). The pegs (5) may utilize compressive technique configured for allowing the pegs (5) to be compressed into the inner hollow portion of the tube when a compressing force is applied. Such compressive techniques are known in the art, and the scope of the invention is not intended to be limited to any particular type or kind either now known or later developed in the future. The second portion (6) is a hollow cylindrical tube having a slightly larger diameter than the first portion (4) such that the first portion (4) can be slidably engaged into the second portion (6), the second portion (6) having a hole (7) at one end for engaging with the pegs (5) of the first portion (4), thereby providing height adjustment. Alternatively, the adjustable pole (10) could have a twist-to-tighten collar rather than the engaging peg (5) and hole (7). The scope of the invention is not intended to be limited to the type, kind or manner of engagement for providing height adjustment of the adjustable pole either now known or later developed in the future.

The end of the second portion (6) of the adjustable pole (10) that is opposite the hole (7) is affixed to the base (9), which has a collar (8) for accepting the adjustable pole (10). The collar (8) may be affixed to the second portion (6) of the adjustable pole (10) using a peg and hole, nut and bolt, pin and hole, threaded twisting or screwing technique, or other suitable engaging techniques. The base (9) is arranged in a cross-beam or x-shaped manner for support and should be sufficiently wide to provide suitable solid support for the paint can stand (1). The scope of the invention is not intended to be limited to the shape of the base or collar affixing techniques either now known or later developed in the future.

The paint can stand (1) is adjustable from one to three feet or three to six feet, but the scope of the invention is not intended to be limited to the adjustable size either now known or later developed in the future.

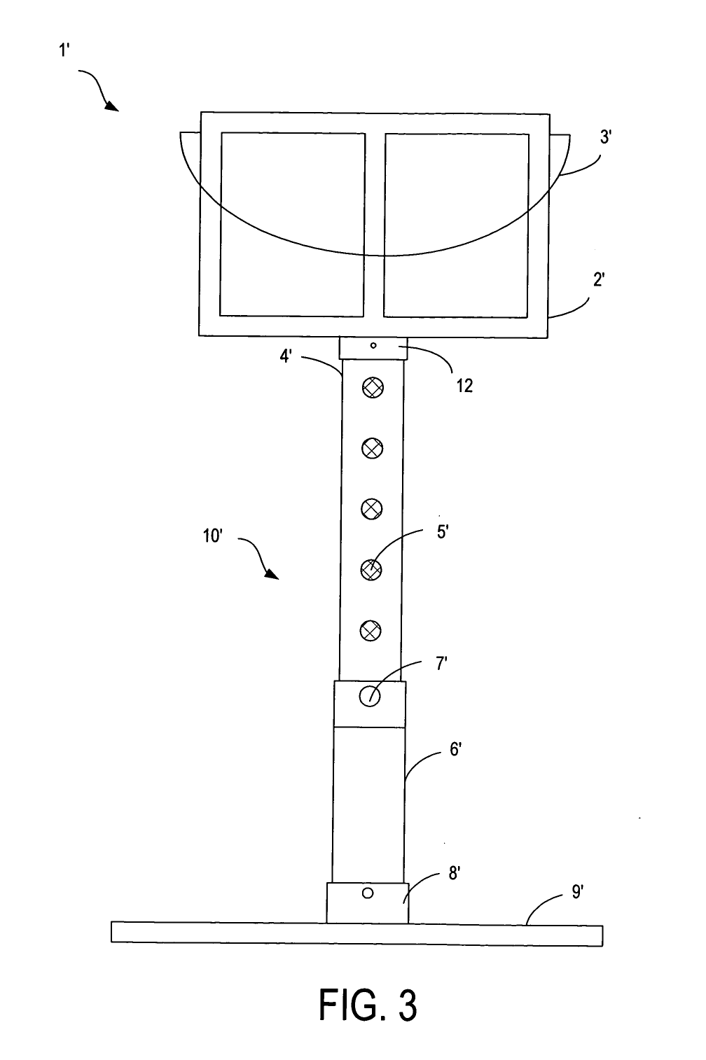

FIG. 3 shows another embodiment of the invention, which is substantially similar in structure and function to the embodiment of FIG. 1. As shown in FIG. 3, the alternative embodiment of the present invention features a paint can stand (1′) having a basket (2′) for engagement with a paint can, the basket (2′) being affixed to an adjustable pole (10′) via a coupler (12), the adjustable pole (10′) being configured for height adjustment of the stand (1′), and the adjustable pole (10′) further being affixed to a base (9′) for support. The basket (2′) is cylindrical in shape and sufficiently wide and deep to contain a standard paint can, and may be comprised of a light band metal. The scope of the invention is not intended to be limited to the type or kind of material of which the basket is comprised of either now known or later developed in the future.

Affixed to the basket (2′) is an easy-swing handle (3′) used for carrying the paint can stand (1′). The handle (3′) is semi-circular in shape and is affixed to opposite sides of the basket (2′). The handle (3′) rests alongside the basket (2′) when in the resting position and is in an arced position above the stand when being carried. The handle (3′) is dimensionally sized to be able to make a full arc swing from side to side while a standard gallon-size paint can is situated inside the basket (2′).

The adjustable pole (10′) comprises two portions, which may be comprised of aluminum or steel. The scope of the invention is not intended to be limited to the type or kind of material from which the adjustable pole is made either now known or later developed in the future. The first portion (4′) is a hollow cylindrical tube affixed at one end to the supportive bottom surface of the basket (2′). The bottom surface of the basket (2′) has a collar (12) for accepting the first portion (4′) of the adjustable pole (10′). The collar (12) may be affixed to the first portion (4′) of the adjustable pole (10′) using a peg and hole, nut and bolt, pin and hole, threaded twisting or screwing technique, or other suitable engaging techniques. The scope of the invention is not intended to be limited to the collar affixing techniques either now known or later developed in the future. Affixed to the first portion (4′) of the adjustable pole (10′) are evenly spaced pegs (5′) for engaging with the second portion (6′) of the adjustable pole (10′). The pegs (5′) may utilize compressive technique configured for allowing the pegs (5′) to be compressed into the inner hollow portion of the tube when a compressing force is applied. Such compressive techniques are known in the art, and the scope of the invention is not intended to be limited to any particular type or kind either now known or later developed in the future. The second portion (6′) is a hollow cylindrical tube having a slightly larger diameter than the first portion (4′) such that the first portion (4′) can be slidably engaged into the second portion (6′), the second portion (6′) having a hole (7′) at one end for engaging with the pegs (5′) of the first portion (4′), thereby providing height adjustment. Alternatively, the adjustable pole (10′) could have a twist-to-tighten collar rather than the engaging peg (5′) and hole (7′). The scope of the invention is not intended to be limited to the type, kind or manner of engagement for providing height adjustment of the adjustable pole either now known or later developed in the future.

The end of the second portion (6′) of the adjustable pole (10′) that is opposite the hole (7′) is affixed to the base (9′), which has a collar (8′) for accepting the adjustable pole (10′). The collar (8′) may be affixed to the second portion (6′) of the adjustable pole (10′) using a peg and hole, nut and bolt, pin and hole, threaded twisting or screwing technique, or other suitable engaging techniques. The base (9′) is arranged in a cross-beam or x-shaped manner for support and should be sufficiently wide to provide suitable solid support for the paint can stand (1′). The scope of the invention is not intended to be limited to the shape of the base or collar affixing techniques either now known or later developed in the future.

The paint can stand (1′) is adjustable from one to three feet or three to six feet, but the scope of the invention is not intended to be limited to the adjustable size either now known or later developed in the future.

### BEST MODE FOR CARRYING OUT THE INVENTION

FIG. 1 shows the assembled paint can stand as described. FIG. 2 shows the separate elements of the paint can stand of FIG. 1.

### THE SCOPE OF THE INVENTION

It should be understood that, unless stated otherwise herein, any of the features, characteristics, alternatives or modifications described regarding a particular embodiment herein may also be applied, used, or incorporated with any other embodiment described herein.

Although the invention has been described and illustrated with respect to exemplary embodiments thereof, the foregoing and various other additions and omissions may be made therein without departing from the spirit and scope of the present invention.

What is claimed is:

1. A paint can stand comprising:
a basket configured for receiving and holding a paint can,
an adjustable pole configured for engaging and supporting said basket, said adjustable pole having a first and second portion,
said first portion having a plurality of aperture and corresponding pegs arranged along its longitudinal axis, each peg being configured to be responsive to a force, for being pushing into a respective aperture when the force is applied, and for being extended outwardly from the respective aperture when the force is not applied, and
said second portion having a hole dimensionally sized for receiving and engaging one of the plurality of said pegs when the force is applied then released so as to adjust the paint can stand to a particular height for holding the paint can in the basket,
a base configured for detachably receiving and securely holding one end of the second portion of said adjustable pole so as to provide a foundation for the paint can stand,
the first portion, the second portion and the base being detachably coupled together so that the paint can stand can be quickly and easily assembled together for use and disassembled and easily stored when not in use.

2. The paint can stand of claim 1, wherein the basket comprises a flexible handle pivotally attached thereto configured for lifting and carrying said paint can stand.

3. The paint can stand of claim 1, wherein said base is configured in a substantially x-shaped arrangement.

4. The paint can stand of claim 1, wherein said base is dimensionally sized to extend outwardly beyond an outermost periphery of said basket for increased base of support.

5. The paint can stand of claim 1, wherein the base comprises a collar configured to removably affix the one end of said second portion of said adjustable pole.

6. The paint can stand of claim 1, wherein said basket is substantially open and having spaced-apart supportive pieces extending from a supportive base of said basket to a top rim of said basket.

7. The paint can stand of claim 6, wherein said supportive base of said basket has a substantially x-shaped configuration.

8. The paint can stand of claim 1, wherein said basket is dimensionally sized to accommodate a gallon-sized paint can.

9. The paint can stand of claim 2, wherein said handle is substantially arc-shaped and dimensionally sized to be able to freely swing from one side of said paint can stand to another side of said paint can stand while a can of paint is engaged in said paint can stand.

10. The paint can stand of claim 1, wherein said basket is made of a light band metal.

11. The paint can stand of claim 1, wherein said adjustable pole is made of aluminum.

12. The paint can stand of claim 1, wherein said adjustable pole is made of steel.

13. The paint can stand of claim 5, wherein said collar is removably affixed to said second portion of said adjustable pole using a peg and hole mechanism.

14. The paint can stand of claim 5, wherein said collar is removably affixed to said second portion of said adjustable pole by screwing the one end of said second portion into the collar.

15. The paint can stand of claim 1, wherein said adjustable pole is extendable from 1 to 3 feet in height.

16. The paint can stand of claim 1, wherein said adjustable pole is extendable from 3 to 6 feet in height.

17. The paint can stand of claim 1, wherein the basket and the first pole portion are detachably coupled together, including being respectively configured for screwing together.

18. A paint can stand comprising:
a basket configured for receiving and holding a paint can;
an adjustable pole configured for detachably engaging and supporting said basket, said adjustable pole having first and second pole portions being dimensioned and configured so that one pole portion fits telescopically inside and slides in relation to the other pole portion so as to adjust the length of the adjustable pole and so that the first and second pole portions frictionally engaging with one another so as to remain frictionally locked in an adjusted position;
a base configured for detachably coupling and securely holding either the first or second pipe portions so as to provide a foundation for the paint can stand;
whereby the basket, the first portion, the second portion and the base all being detachably coupled together so that the paint can stand can be quickly and easily assembled together for use and disassembled and easily stored when not in use.
